(19) United States
(12) Patent Application Publication
(10) Pub. No.: US 2023/0303002 A1
(43) Pub. Date: Sep. 28, 2023

(54) FOLDABLE MOBILE STEP APPARATUS

(71) Applicant: Team Industrial Services, Inc., Sugar Land, TX (US)

(72) Inventor: James Alton KANE, White Deer, TX (US)

(21) Appl. No.: 18/022,242

(22) PCT Filed: Aug. 19, 2021
(86) PCT No.: PCT/US2021/046793

§ 371 Date: Feb. 20, 2023

Related U.S. Application Data
(60) Provisional application No. 63/074,713, filed on Sep. 4, 2020.

(51) Int. Cl. B60R 3/02; B60R 13/10

(52) U.S. Cl. CPC B60R 3/02; B60R 13/105

(57) ABSTRACT

A technique is provided for facilitating access into a truck bed. The technique utilizes a step assembly which is foldable between an operational configuration and a folded, transport configuration. The foldable step assembly may comprise a support structure having an attachment end which may be sized for receipt in a hitch receiver of a vehicle, e.g. a truck. The foldable step assembly also may comprise an upper step structure having an upper step mounted to an upper step frame pivotably coupled with the support structure for pivoting movement between a lateral position and an upright transport position. Additionally, a handrail may be pivotably coupled with the upper step structure for pivoting movement between an upright use position and a folded transport position. Furthermore, the step assembly may comprise a lower step structure having a lower step and a lower step frame constructed for pivoting movement between a lower lateral position and a position folded over the upper step.

### CROSS-REFERENCE TO RELATED APPLICATION

The present document is based on and claims priority to U.S. Provisional Application Ser. No. 63/074,713 him, filed Sep. 4, 2020, which is incorporated herein by reference in its entirety.

### FIELD OF DISCLOSURE

In general, the disclosure describes a foldable mobile step system which may be used to facilitate access into and out of a vehicle bed, e.g. a truck bed. The foldable mobile step system may be releasably mounted at the back of a truck in a folded position and then unfolded when accessing the bed of the truck.

### BACKGROUND OF DISCLOSURE

Many types of trucks, e.g. pickup style trucks, have beds for hauling materials, equipment, or other items. Sometimes access to the truck bed is useful, but such access can be difficult. For example, many truck beds are at least 3 feet from the ground and this height can make access to the bed of the truck difficult. Various types of single steps have been mounted at the backs of trucks, but single steps still require a person accessing the truck bed to undertake a two-step process with relatively high steps onto the single step and then into the bed of the truck. Additionally, current systems either do not utilize a handrail or provide handrails which are awkward to use or provide a tripping point.

What is needed is an improved step system to facilitate easy, safe ingress and egress with respect to the bed of a pickup truck or other type of vehicle.

### SUMMARY

This summary is provided to introduce a selection of concepts that are further described below in the detailed description. However, many modifications are possible without materially departing from the teachings of this disclosure. Accordingly, such modifications are intended to be included within the scope of this disclosure as defined in the claims. This summary is not intended to identify key or essential features of the claimed subject matter, nor is it intended to be used as an aid in limiting the scope of the claimed subject matter.

An embodiment of the present disclosure provides a system for facilitating access into a truck bed. The system comprises a step assembly which is foldable between an operational configuration and a folded, transport configuration. The foldable step assembly comprises a support structure having an attachment end for coupling with a vehicle. For example, the attachment end may be sized for receipt in a hitch receiver of a vehicle, e.g. a truck. The foldable step assembly also comprises an upper step structure having an upper step mounted to an upper step frame. The upper step frame is pivotably coupled with the support structure for pivoting movement between a lateral position and an upright transport position. Additionally, the foldable step assembly may comprise a handrail pivotably coupled with the upper step structure for pivoting movement between an upright use position and a folded transport position. Furthermore, the step assembly comprises a lower step structure having a lower step and a lower step frame. The lower step frame may be pivotably coupled with the upper step structure for pivoting movement between a lower lateral position and a position folded over the upper step. With this construction, the foldable step assembly is easily connected into, for example, a hitch receiver of the truck or other vehicle and then readily unfolded to enable a three-step process for entering the vehicle/truck bed via relatively short steps.

### BRIEF DESCRIPTION OF THE FIGURES

Certain embodiments of the disclosure will hereafter be described with reference to the accompanying drawings, wherein like reference numerals denote like elements. It is emphasized that, in accordance with standard practice in the industry, various features are not drawn to scale. In fact, the dimensions of various features may be arbitrarily increased or reduced for clarity of discussion. It should be understood, however, that the accompanying figures illustrate the various implementations described herein and are not meant to limit the scope of various technologies described herein, and:

FIG. 1 is a rear view of a foldable step assembly mounted to a vehicle in an unfolded, operational position at a rear of the vehicle in accordance with embodiments of the present disclosure;

FIG. 2 is a side view of the foldable step assembly illustrated in FIG. 1 in accordance with embodiments of the present disclosure;

FIG. 3 is a side view of the foldable step assembly in a partially folded configuration in accordance with embodiments of the present disclosure;

FIG. 4 is a side view of the foldable step assembly in another partially folded configuration in accordance with embodiments of the present disclosure; and

FIG. 5 is a side view of the foldable step assembly in folded, transport configuration in accordance with embodiments of the present disclosure.

### DETAILED DESCRIPTION

In the following description, numerous details are set forth to provide an understanding of some embodiments of the present disclosure. It is to be understood that the following disclosure provides many different embodiments, or examples, for implementing different features of various embodiments. Specific examples of components and arrangements are described below to simplify the disclosure. These are, of course, merely examples and are not intended to be limiting. In addition, the disclosure may repeat reference numerals and/or letters in the various examples. This repetition is for the purpose of simplicity and clarity and does not in itself dictate a relationship between the various embodiments and/or configurations discussed. However, it will be understood by those of ordinary skill in the art that the system and/or methodology may be practiced without these details and that numerous variations or modifications from the described embodiments are possible. This description is not to be taken in a limiting sense, but rather made merely for the purpose of describing general principles of the implementations. The scope of the described implementations should be ascertained with reference to the issued claims.

As used herein, the terms “connect”, “connection”, “connected”, “in connection with”, and “connecting” are used to mean “in direct connection with” or “in connection with via one or more elements”; and the term “set” is used to mean “one element” or “more than one element”. Further, the terms “couple”, “coupling”, “coupled”, “coupled together”, and “coupled with” are used to mean “directly coupled together” or “coupled together via one or more elements”. As used herein, the terms “up” and “down”; “upper” and “lower”; “top” and “bottom”; and other like terms indicating relative positions to a given point or element are utilized to more clearly describe some elements.

According to an embodiment, a system is provided for facilitating access into a bed of a vehicle, e.g. access into a truck bed. The system comprises a step assembly which is foldable between an operational configuration and a folded, transport configuration. The foldable step assembly comprises a support structure having an attachment end which may be coupled with a vehicle. For example, the attachment end may be sized for receipt in a hitch receiver of a truck or other vehicle. In some applications, the foldable step assembly may be constructed for releasable insertion into a standard 2″×2″ hitch receiver of a pickup style truck or other vehicle.

The foldable step assembly also may comprise an upper step structure having an upper step mounted to an upper step frame. The upper step frame may be pivotably coupled with the support structure for pivoting movement between a lateral position and an upright transport position. Additionally, the foldable step assembly may comprise a handrail pivotably coupled with the upper step structure for pivoting movement between an upright use position and a folded transport position.

Furthermore, the step assembly may comprise a lower step structure having a lower step and a lower step frame. The lower step frame may be pivotably coupled with the upper step structure for pivoting movement between a lower lateral position and a position folded over the upper step. With this construction, the foldable step assembly is easily connected into a hitch receiver of the truck or other vehicle and then readily unfolded to enable a three-step process for entering the truck bed via relatively short steps.

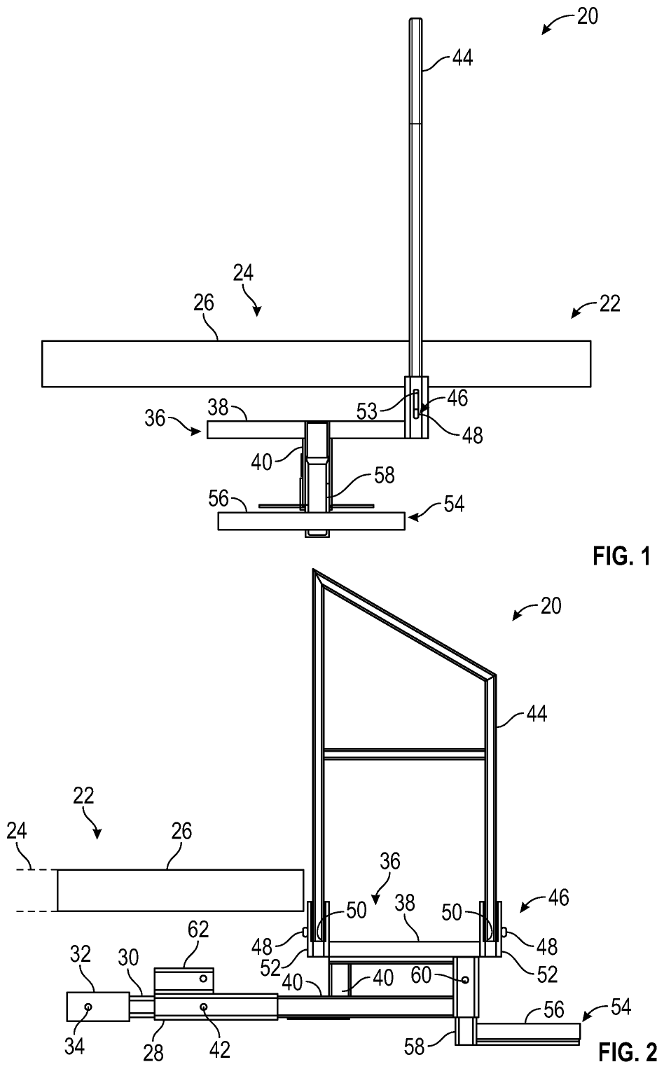

Referring generally to FIG. 1, an example of a foldable step assembly 20 is illustrated in an unfolded configuration at the rear of a vehicle 22. By way of example, the vehicle 22 may be a truck having a bed 24. In this example, the truck 22 also has a foldable tailgate 26 which may be folded down to a flat position, as illustrated in FIGS. 1 and 2. The step assembly 20 is foldable between an unfolded, operational or use configuration (as illustrated in FIGS. 1 and 2) and a folded transport configuration.

As illustrated, the foldable step assembly 20 comprises a support structure 28 having an attachment end 30 configured for attachment to vehicle 22. For example, attachment end 30 may be configured and sized for receipt in a hitch receiver 32 of the vehicle/truck 22. The attachment end 30 may be secured in the hitch receiver 32 via a conventional pin 34 or other suitable attachment mechanism. The step assembly 20 further may comprise an upper step structure 36 which has an upper step 38 mounted to an upper step frame 40. The upper step frame 40 may be pivotably coupled with the support structure 28 via a pivot 42, e.g. a pivot pin, for pivoting movement between a lateral position, as illustrated in FIG. 2, and an upright transport position.

According to the illustrated embodiment, the step assembly 20 also may comprise a handrail 44 which may be connected into the foldable step assembly 20 at various points. In the example illustrated, handrail 44 is pivotably coupled with the upper step structure 36, via a pivot 46, for pivoting movement between an upright use position and a folded transport position. By way of example, the pivot 36 may comprise a pair of pivot pins 48 or other suitable pivot structures. In some embodiments, ends 50 of handrail 44 are received in corresponding receptacles 52 of upper step structure 36 when handrail 44 is in the upright use position. The handrail 44 may be folded to the transport position by lifting ends 50 from receptacles 52 and then pivoting the handrail 44 about pivot pins 48. The pivot pins 48 may be arranged in corresponding pivot pin slots 53 so as to enable the lifting and pivoting of handrail 44 (see FIG. 1).

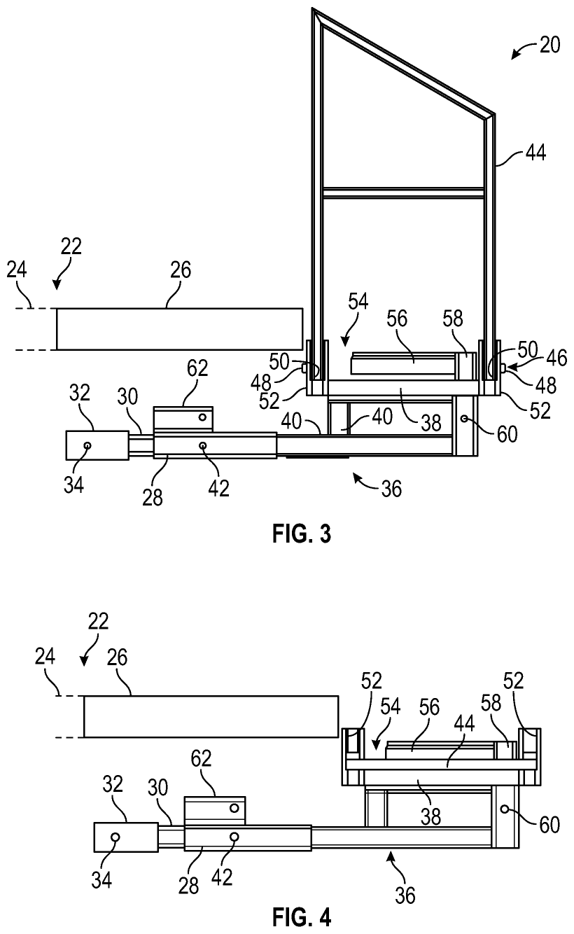

As illustrated, the step assembly 20 also may comprise a lower step structure 54 having a lower step 56 supported on a lower step frame 58. By way of example, the lower step frame 58 may be pivotably coupled with the upper step structure 36, via a pivot 60, for pivoting movement between a lower lateral position (see FIGS. 1 and 2) and a position folded over the upper step 38. In this position, the lower step 56 may be located, for example, at a position generally parallel with the upper step 38 and above the upper step 38 (see FIG. 3). The pivot 60 may be in the form of a pivot pin or other suitable hinge or pivot configuration. As illustrated best in FIG. 2, the length of the support structure 28 may be selected so that the upper step 38 and the handrail 44 are to the rear of the lowered tailgate 26 when the attachment end 30 is secured in the hitch receiver 32 via pin 34 or other attachment mechanism. This allows an individual to use a three-step process to enter the truck bed 24 by simply stepping first onto lower step 56, then onto upper step 38, and subsequently into bed 24 via tailgate 26 while gripping handrail 44. The lower step 56 and upper step 38 may be arranged such that each successive step by a person accessing the bed 24 is approximately 10-12 inches in the vertical direction (although other vertical spacing lengths may be selected).

To convert the step assembly 20 from the operational/use position to a folded transport position, the lower step 56 and lower step frame 58 are pivoted about the pivot 60 until the lower step 56 is inverted and positioned directly above the upper step 38, as illustrated in FIG. 3. Subsequently, the handrail 44 is lifted free of handrail receptacles 52 and pivoted about pivot 46, e.g. about pivot pins 48, into a lateral or flat position generally above upper step 38, as illustrated in FIG. 4. Although the step assembly 20 could be constructed to enable initial closure of either the lower step 56 or the handrail 44, the illustrated embodiment employs an initial folding of the lower step 56. The handrail 44 may be positioned such that when the handrail 44 is subsequently folded into the lateral, transport position illustrated in FIG. 4, the lower step 56 is blocked from unfolding. (This sequence also ensures that the handrail 44 must be unfolded to the upright position before the lower step 56 is unfolded during transition of the step assembly 20 from the transport configuration to the unfolded, operational configuration.)

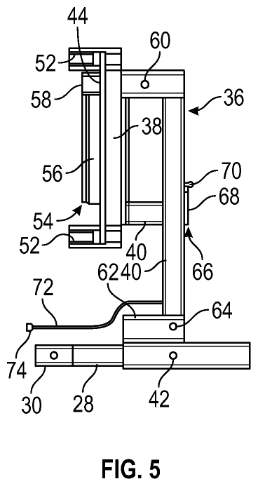

Subsequently, the combined lower step structure 54, upper step structure 36, and handrail 44 may be pivoted from the lateral position illustrated in FIG. 4 to the upright transport position illustrated in FIG. 5. Pivoting to the upright transport position is achieved by pivoting the upper step structure 36 about pivot 42 until the combined lower step structure 54, upper step structure 36, and handrail 44 are placed in the upright transport position. In the illustrated example, the upper step frame 40 of upper step structure 36 pivots into a retention structure 62. The assembly may be locked in this upright transport position via a lock pin 64 extending through retention structure 62 and upper step frame 40. However, other types of locking mechanisms may be used to secure the step assembly 20 in the folded, upright, travel position illustrated in FIG. 5. To unfold step assembly 20 to the operational position illustrated in FIG. 2, the process is simply reversed.

In some embodiments, a license plate holder 66 may be positioned along a bottom of the upper step structure 36 so that a license plate 68 is visible when the step assembly 20 is folded into the transport configuration illustrated in FIG. 5. An appropriate license plate light 70 may be positioned to shine on the license plate 68. A suitable wiring harness 72 may be routed from the license plate light 70 to a plug 74 which may be plugged into a corresponding electrical socket on the vehicle/truck 22.

The step assembly 20 may be made from steel or other metal materials. However, the step assembly 20 also can be constructed in whole or in part from plastics or other suitable materials. The configuration and size of the steps and handrail may be adjusted according to the environment, vehicle type, and intended use of the step assembly. Similarly, various types of pivots and locking mechanisms may be incorporated into the overall step assembly 20.

Although a few embodiments of the disclosure have been described in detail above, those of ordinary skill in the art will readily appreciate that many modifications are possible without materially departing from the teachings of this disclosure. For example, the pipe isolation device of the present disclosure may be modified by adding additional sealing heads to become a triple, or more, block and bleed apparatus. Accordingly, such modifications are intended to be included within the scope of this disclosure as defined in the claims. The scope of the invention should be determined only by the language of the claims that follow. The term “comprising” within the claims is intended to mean “including at least” such that the recited listing of elements in a claim are an open group. The terms “a,” “an” and other singular terms are intended to include the plural forms thereof unless specifically excluded.

What is claimed is:

1. A system for facilitating access into a vehicle bed, comprising:
a step assembly foldable between an operational configuration and a transport configuration, the step assembly comprising:
a support structure having an attachment end sized for receipt in a hitch receiver of a vehicle;
an upper step structure having an upper step mounted to an upper step frame, the upper step frame being pivotably coupled with the support structure for pivoting movement between a lateral position and an upright transport position;
a handrail pivotably coupled with the upper step structure for pivoting movement between an upright use position and a folded transport position; and
a lower step structure having a lower step supported on a lower step frame, the lower step frame being pivotably coupled with the upper step structure for pivoting movement between a lower lateral position and a position folded over the upper step.

2. The system as recited in claim 1, further comprising a license plate holder positioned to be visible when the step assembly is folded into the transport configuration and while the attachment end is in the hitch receiver.

3. The system as recited in claim 1, wherein the vehicle is a pickup truck having a tailgate.

4. The system as recited in claim 3, wherein the attachment and is sized for receipt in a two inch by two inch hitch receiver.

5. The system as recited in claim 1, wherein the step assembly further comprises a retention structure for receiving and retaining the upper step structure when the step assembly is in the transport configuration.

6. The system as recited in claim 5, wherein the upper step structure is retained in the retention structure via a lock pin.

7. The system as recited in claim 1, wherein the handrail is received in handrail receptacles when in the upright use position.

8. The system as recited in claim 1, wherein the lower step is generally parallel with and above the upper step when the lower step frame is pivoted to the position folded over the upper step.

9. The system as recited in claim 1, wherein the lower step frame is pivotably coupled with the upper step structure via a pivot pin.

10. The system as recited in claim 1, wherein the handrail secures the lower step over the upper step when the handrail is in the folded transport position and the lower step frame is in the position folded over the upper step.

11. A system, comprising:
a step assembly foldable between an operational configuration and a transport configuration, the step assembly comprising:
a support structure removably attachable to a vehicle;
an upper step structure having an upper step mounted to an upper step frame, the upper step frame being pivotably coupled with the support structure for pivoting movement between a lateral position and an upright transport position; and
a lower step structure having a lower step supported on a lower step frame, the lower step frame being pivotably coupled with the upper step structure for pivoting movement between a lower lateral position and a position folded over the upper step.

12. The system as recited in claim 11, further comprising a handrail pivotably coupled with the upper step structure for pivoting movement between an upright use position and a folded transport position.

13. The system as recited in claim 12, wherein the support structure as an attachment end sized for receipt in a hitch receiver of the vehicle.

14. The system as recited in claim 13, wherein the vehicle is a pickup truck having a tailgate.

15. The system as recited in claim 13, wherein the attachment end is sized for receipt in a two inch by two inch hitch receiver.

16. The system as recited in claim 15, wherein the step assembly further comprises a retention structure for receiving and retaining the upper step structure when the step assembly is in the transport configuration.

17. The system as recited in claim 16, wherein the upper step structure is retained in the retention structure via a lock pin.

18. A method, comprising:
providing a step assembly with a support structure having an attachment end sized for insertion into a hitch receiver of a vehicle;
pivotably coupling an upper step structure to the support structure for pivotable movement between a use position and a folded transport position; and
movably mounting a lower step structure to the upper step structure for movement between a lower lateral use position and a folded position, at which folded position the upper step structure may be pivoted to the folded transport position.

19. The method as recited in claim 18, wherein providing comprises providing the step assembly with a foldable handrail.

20. The method as recited in claim 19, further comprising sizing the attachment end for receipt in the hitch receiver sized as a two inch by two inch hitch receiver.
